(19) United States
(12) Patent Application Publication
(10) Pub. No.: US 2026/0273949 A1
(43) Pub. Date: Sep. 17, 2026

(54) LIQUID EJECTION HEAD AND LIQUID EJECTION APPARATUS

(71) Applicant: CANON KABUSHIKI KAISHA, Tokyo (JP)

(72) Inventor: KAZUYUKI YOSHIDA, Kanagawa (JP)

(21) Appl. No.: 19/561,810

(22) Filed: Mar. 10, 2026

(30) Foreign Application Priority Data
Mar. 11, 2025 (JP) 2025-038340

(51) Int. Cl. B41J 2/18; B41J 2/045; B41J 2/175

(52) U.S. Cl. CPC B41J 2/18; B41J 2/04501; B41J 2/17503; B41J 2/17596

(57) ABSTRACT

A liquid ejection head includes: a liquid ejection unit configured to eject a liquid; a tank configured to store the liquid to be supplied to the liquid ejection unit; and a circulation pump configured to circulate the liquid between the tank and the liquid ejection unit. The circulation pump includes a pump chamber in which an inner volume is changed, a suction port configured to allow for entry of the liquid but not to allow for discharge of the liquid, and multiple discharge ports configured to allow for discharge of the liquid but not to allow for entry of the liquid.

### BACKGROUND

### Field of the Technology

The present disclosure relates to a liquid ejection head and a liquid ejection apparatus.

### Description of the Related Art

In general, there is a liquid ejection head that is capable of circulating a liquid between a liquid ejection unit configured to eject the liquid and a pressure control unit configured to control pressure.

Japanese Patent Laid Open-No. 2022-334 discloses a liquid ejection head that is capable of circulating a liquid between a pressure regulator (pressure control tank) configured to control pressure and a printing element substrate (liquid ejection unit) configured to eject the liquid. In the pressure regulator of Japanese Patent Laid Open-No. 2022-334, a suction port through which the liquid is sucked and a discharge port through which the liquid is discharged are formed. The discharge port is formed on an upper side of the suction port in a vertical direction. According to this configuration, in general, a bubble rises in the vertical direction, and therefore easy discharge of the liquid and the bubble existing inside the pressure regulator from the discharge port is implemented.

### SUMMARY

However, in the pressure regulator of Japanese Patent Laid Open-No. 2022-334, there is a space further above the discharge port. Accordingly, in a case where the bubble stagnates in this space, it is difficult to discharge the bubble, and there has been concern about a pressure loss in a circulation path.

The present disclosure is to provide a liquid ejection head that can discharge a bubble more easily.

A liquid ejection head of the present disclosure includes: a liquid ejection unit configured to eject a liquid; a tank configured to store the liquid to be supplied to the liquid ejection unit; and a circulation pump configured to circulate the liquid between the tank and the liquid ejection unit, in which the circulation pump includes a pump chamber in which an inner volume is changed, a suction port configured to allow for entry of the liquid but not to allow for discharge of the liquid, and multiple discharge ports configured to allow for discharge of the liquid but not to allow for entry of the liquid.

Features of the present disclosure will become apparent from the following description of embodiments with reference to the attached drawings. The following description of embodiments are described by way of example.

### BRIEF DESCRIPTION OF THE DRAWINGS

FIG. 1 is an exterior perspective view of a liquid ejection head in an embodiment;

FIG. 2 is a diagram describing a flow of a liquid in an embodiment;

FIG. 3A is a schematic plan view of a pressure control tank in an embodiment;

FIG. 3B is a schematic front view of the pressure control tank in an embodiment;

FIG. 3C is a schematic side view of the pressure control tank in an embodiment;

FIG. 4 is an exterior perspective view of a circulation pump in an embodiment;

FIG. 5 is an exploded perspective view of the circulation pump in an embodiment;

FIG. 6A is a diagram describing a flow of the liquid in a case where the liquid is sucked into a pump chamber of an embodiment;

FIG. 6B is a diagram describing a flow of the liquid in a case where the liquid is discharged from the pump chamber of an embodiment;

FIG. 7 is a schematic view of the circulation pump in an embodiment;

FIG. 8A is a schematic plan view of the liquid ejection head in an embodiment;

FIG. 8B is a schematic front view of the liquid ejection head in an embodiment;

FIG. 8C is a schematic side view of the liquid ejection head in an embodiment;

FIG. 9 is a diagram illustrating a modification of the pump chamber in an embodiment;

FIG. 10A is a schematic plan view of the liquid ejection head in an embodiment;

FIG. 10B is a schematic front view of the liquid ejection head in an embodiment;

FIG. 10C is a schematic side view of the liquid ejection head in an embodiment;

FIG. 11 is a schematic front view of the circulation pump in an embodiment; and

FIG. 12 is a diagram illustrating a modification of the pump chamber in an embodiment.

### DESCRIPTION OF THE EMBODIMENTS

Hereinafter, a technique of the present disclosure is described with reference to the drawings. Note that, the following embodiments are not intended to limit the technical scope of the present disclosure. Additionally, not all the combinations of characteristics described in the present disclosure are necessarily the essential constituents. Note that, the same constituents are denoted by the same reference numerals.

### First Embodiment

### Liquid Ejection Head 1

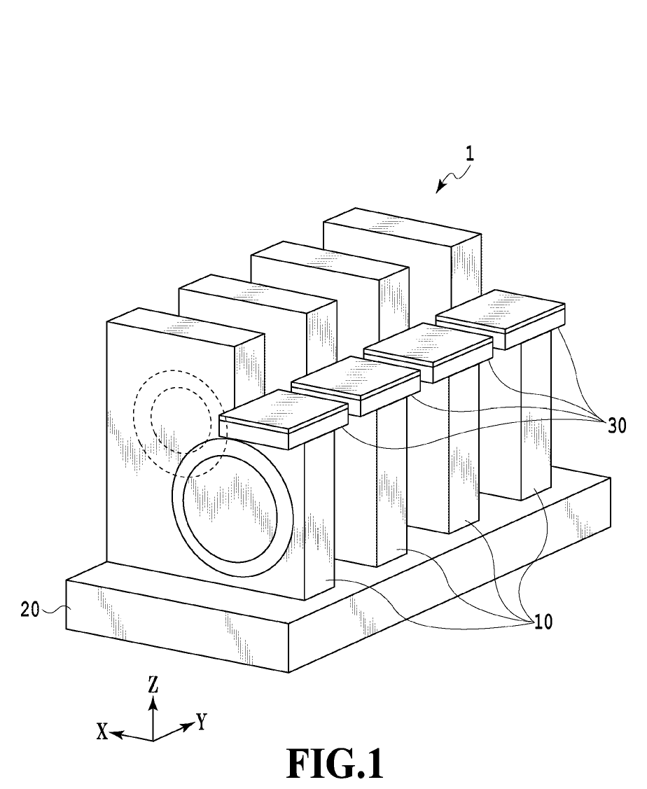

FIG. 1 is an exterior perspective view of a liquid ejection head 1 in the present embodiment.

A coordinate axis illustrated in the drawing of the present disclosure is described. An X direction corresponds to a width direction (right and left direction) of the liquid ejection head 1. A Y direction corresponds to a depth direction of the liquid ejection head 1. A Z direction corresponds to a height direction of the liquid ejection head 1 and indicates an antigravity direction.

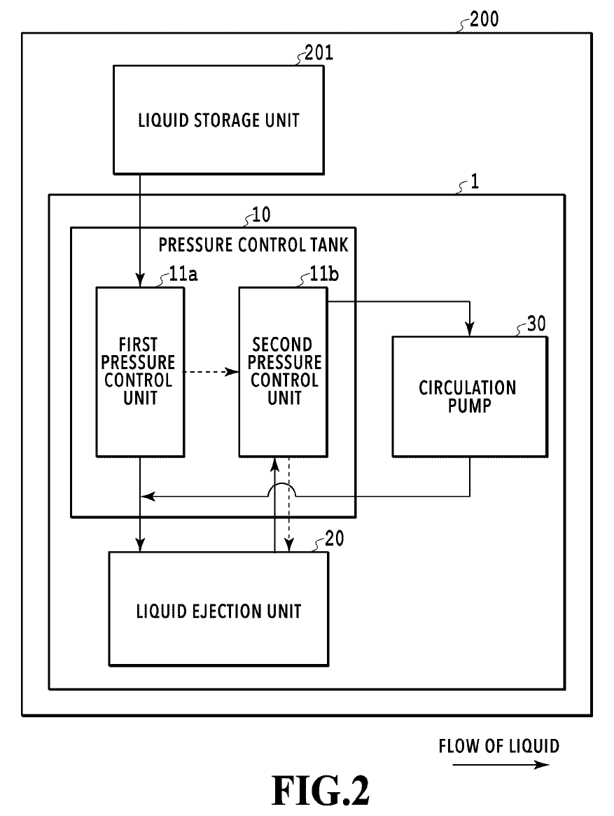

The liquid ejection head 1 illustrated in FIG. 1 is configured to be able to eject a liquid (for example, ink). As illustrated in FIG. 1, the liquid ejection head 1 includes a pressure control tank 10 that performs pressure control to control an internal pressure to be within a predetermined range and temporarily stores the liquid supplied from a liquid storage unit 201 (see FIG. 2) storing a relatively great amount of liquid.

The liquid ejection head 1 includes a liquid ejection unit 20 including an ejection port (not illustrated) through which the liquid supplied from the pressure control tank 10 is ejected and a circulation pump 30 that circulates the liquid between the pressure control tank 10 and the liquid ejection unit 20. In the liquid ejection head 1, multiple pressure control tanks 10 are connected to one liquid ejection unit 20. The multiple pressure control tanks 10 store different types of liquid, respectively.

In the liquid ejection head 1 of the present embodiment, four pressure control tanks 10 are connected to the one liquid ejection unit 20. The four pressure control tanks 10 store inks of yellow, magenta, cyan, and black, respectively, for example. In addition, full-color printing is performed by ejecting the four colors of inks from the liquid ejection unit 20 onto a printing medium (for example, not-illustrated sheet).

FIG. 2 is a diagram describing a flow of the liquid in the inside of a liquid ejection apparatus 200 in the present embodiment. FIG. 1 illustrates the four pressure control tanks 10. However, FIG. 2 illustrates only one pressure control tank 10 for the sake of explanatory convenience. The configurations of the above-described four pressure control tanks 10 are all same except the type of the stored ink. An arrow of a solid line in FIG. 2 indicates a direction in which the liquid flows. Note that, in a case where there is a great consumption amount of the liquid, the liquid may be supplied to the liquid ejection unit 20 along an arrow illustrated with a broken line.

As illustrated in FIG. 2, the liquid ejection apparatus 200 of the present embodiment includes the liquid storage unit 201 (for example, liquid tank storing ink) that stores a greater amount of the liquid than the pressure control tank 10 can store.

A first pressure control unit 11a and a second pressure control unit 11b that control a pressure to be within a predetermined range are provided inside the pressure control tank 10. The first pressure control unit 11a controls a pressure of the liquid supplied from the liquid storage unit 201. On the other hand, the second pressure control unit 11b controls a pressure of the liquid to be supplied to the liquid ejection unit 20.

Hereinafter, the flow of the liquid in the inside of the liquid ejection apparatus 200 of the present embodiment is described.

First, the liquid is supplied from the liquid storage unit 201 to the first pressure control unit 11a. Next, the liquid is supplied from the first pressure control unit 11a to the liquid ejection unit 20. The liquid supplied to the liquid ejection unit 20 is ejected to the outside from the ejection port (not illustrated) formed in a liquid ejection substrate (not illustrated) provided to the liquid ejection unit 20 according to ejection data.

The liquid that is not ejected from the liquid ejection unit 20 is collected into the second pressure control unit 11b. Next, the liquid is supplied from the second pressure control unit 11b to the circulation pump 30. Next, the liquid is supplied from the circulation pump 30 to a flow channel that is formed inside the pressure control tank 10 and connects the first pressure control unit 11a and the liquid ejection unit 20. Then, the liquid is supplied again from the flow channel to the liquid ejection unit 20.

As described above, in the inside of the liquid ejection head 1 of the present embodiment, the liquid discharged from the circulation pump 30 is returned into the pressure control tank 10. However, the liquid discharged from the circulation pump 30 may be returned to the liquid storage unit 201.

The above is the description of the flow of the liquid in the inside of the liquid ejection apparatus 200 of the present embodiment.

### Pressure Control Tank 10

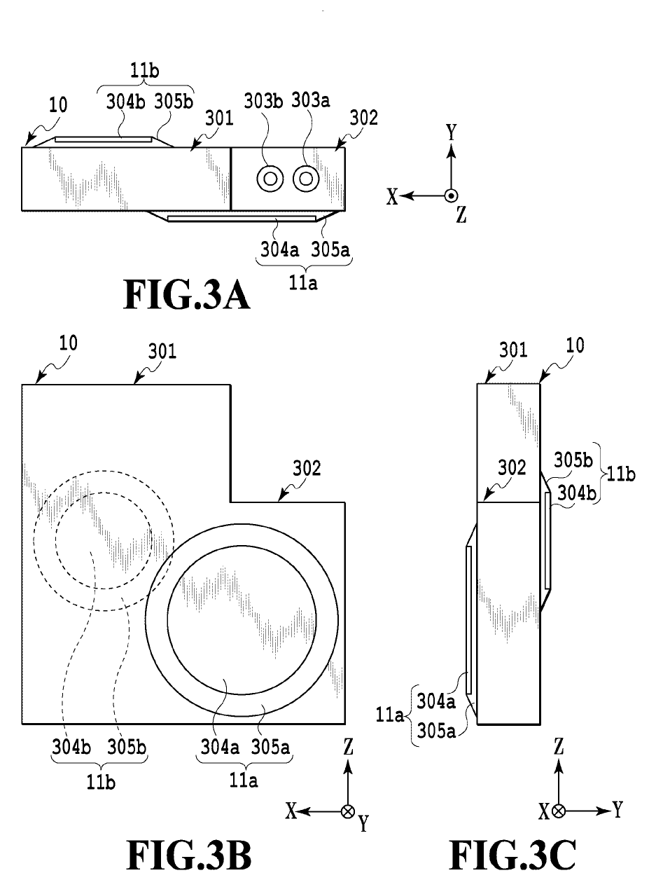

FIG. 3A is a schematic plan view of the pressure control tank 10 of the present embodiment. FIG. 3B is a schematic front view of the pressure control tank 10 of the present embodiment. FIG. 3C is a schematic side view of the pressure control tank 10 of the present embodiment.

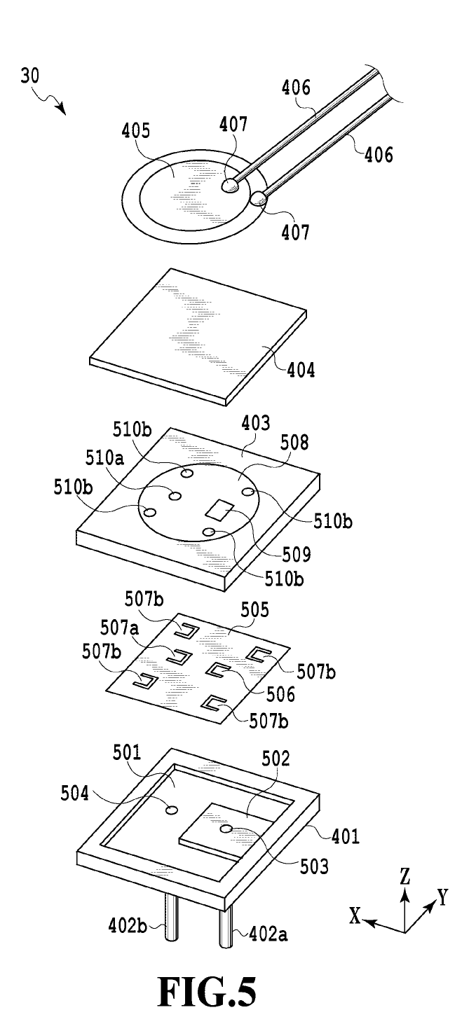

As illustrated in FIGS. 3A to 3C, the pressure control tank 10 includes a first upper surface 301 and a second upper surface 302 that are positioned at different heights. A first connection port 303a that is fluidically connected to a suction tube 402a (see FIG. 5) included in the circulation pump 30 (see FIG. 5 and the like) and a second connection port 303b fluidically connected to a discharge tube 402b (see FIG. 5) are formed in the second upper surface 302.

Specifically, the suction tube 402a (see FIG. 5) of the circulation pump 30 is inserted into the first connection port 303a, and the discharge tube 402b (see FIG. 5) of the circulation pump 30 is inserted into the second connection port 303b. With the circulation pump 30 being connected to the pressure control tank 10 to drive the circulation pump 30, it is possible to circulate the liquid between the pressure control tank 10 and the liquid ejection unit 20 (see FIG. 2 and the like).

The first pressure control unit 11a is provided to a front surface of the pressure control tank 10. The first pressure control unit 11a includes a first disk plate 304a in a circular shape, a first film 305a having flexibility, and an extendable spring (not illustrated). The spring is provided inside the first pressure control unit 11a. The first disk plate 304a receives spring force of the spring. The first film 305a is welded on the first disk plate 304a. The first film 305a is deformed according to the extension and contraction of the spring.

In the pressure control tank 10, with the first film 305a being deformed according to a pressure change of the liquid and the first disk plate 304a pressing the spring, a valve (not illustrated) provided inside the first pressure control unit 11a opens and closes. Thus, the liquid is appropriately supplied from the liquid storage unit 201 (see FIG. 2) to the first pressure control unit 11a. In addition, in the first pressure control unit 11a, first pressure control is performed such that a pressure value falls within a first range by the above-described action of the spring.

Thus, in the first pressure control unit 11a, the first pressure control is performed by the deformation of the first film 305a. Therefore, in a case where a bubble is mixed in the liquid supplied to the first pressure control unit 11a, the first film 305a cannot be properly expanded depending on the amount of the bubble, and it is difficult to normally perform the first pressure control.

Additionally, in the inside of the liquid ejection head 1 (see FIG. 1), the pressure of the liquid is set to be lower than atmospheric pressure. Therefore, there is a possibility that a gas is mixed into the first pressure control unit 11a from the atmospheric air through the first film 305a over time, and the bubble is generated.

The bubble mixed in the liquid rises upward in a vertical direction (Z direction). In order to allow the bubble to be discharged easily from the first pressure control unit 11a by utilizing this property, the spring of the first pressure control unit 11a is provided to extend and contract in a horizontal direction (Y direction).

On the other hand, the second pressure control unit 11b is provided to a back surface of the pressure control tank 10. The second pressure control unit 11b includes a second disk plate 304b in a circular shape, a second film 305b having flexibility, and an extendable spring (not illustrated).

The first pressure control unit 11a and the second pressure control unit 11b have different spring forces of the used springs, respectively, and different pressures are set to the first pressure control unit 11a and the second pressure control unit 11b, respectively.

### Circulation Pump 30

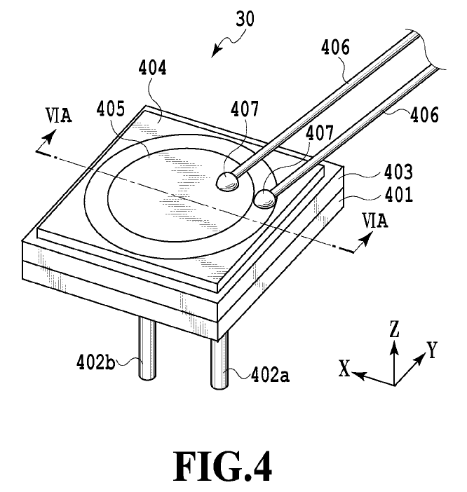

FIG. 4 is a schematic exterior perspective view illustrating an example of the circulation pump 30 in the present embodiment.

As illustrated in FIG. 4, the circulation pump 30 includes a connection member 401 connected to the pressure control tank 10 (see FIG. 3 and the like). In the connection member 401, the suction tube 402a connected to the first connection port 303a of the pressure control tank 10 (see FIG. 3) and the discharge tube 402b connected to the second connection port 303b (see FIG. 3) are formed.

A lower surface (surface facing downward in FIG. 4) of a housing 403 forming a base portion of the circulation pump 30 is fixed (for example, bonded) on an upper surface (surface facing upward in FIG. 4) of the connection member 401. A lower surface (surface facing downward in FIG. 4) of a diaphragm 404 having flexibility is fixed (for example, bonded) on an upper surface (surface facing upward in FIG. 4) of the housing 403.

An actuator 405 (for example, piezoelectric element) that is driven by being supplied with power from an external power source (not illustrated) provided outside the circulation pump 30 is laminated on an upper surface (surface facing upward in FIG. 4) of the diaphragm 404. The external power source and the actuator 405 are connected to each other via wiring 406. The wiring 406 is fixed to the actuator 405 by solder 407.

FIG. 5 is an exploded perspective view of the circulation pump 30 in the present embodiment.

As illustrated in FIG. 5, a first recess 501 that is recessed from the upper surface toward a lower surface is formed on the connection member 401. A protrusion 502 that protrudes from a bottom surface of the first recess 501 toward the upper surface of the connection member 401 is formed on the connection member 401. A first opening portion 503 that is fluidically connected to the suction tube 402a is formed in the protrusion 502.

The first opening portion 503 of the present embodiment penetrates through the protrusion 502 along the vertical direction (Z direction). On the other hand, a second opening portion 504 through which the liquid is discharged from the first recess 501 to the outside is formed in the bottom surface of the first recess 501. The second opening portion 504 is fluidically connected to the discharge tube 402b.

A valve unit 505 including a sheet-shaped valve having flexibility is arranged between an upper surface of the protrusion 502 and the lower surface of the housing 403. An example of material of the valve unit 505 includes resin having elasticity (rubber and the like).

A suction valve 506 that allows for suction of the liquid but does not allow for discharge of the liquid is formed in the valve unit 505. In addition, a first discharge valve 507aand a second discharge valve 507b that allow for discharge of the liquid but does not allow for suction of the liquid are formed in the valve unit 505.

Additionally, an outer periphery of the valve unit 505 is smaller than an opening of the first recess 501. A thickness of the valve unit 505 is the same as a length from the upper surface of the protrusion 502 to the upper surface of the connection member 401. According to this configuration, in a state in which the valve unit 505 is arranged between the upper surface of the protrusion 502 and the lower surface of the housing 403, an upper surface of the valve unit 505 and the upper surface of the connection member 401 are positioned at the same height.

Accordingly, in a state in which the valve unit 505 is arranged between the connection member 401 and the housing 403, the lower surface of the housing 403 is put in contact with both the upper surface of the connection member 401 and upper surface of the valve unit 505. According to this configuration, as long as the suction valve 506, the first discharge valve 507a, and the second discharge valve 507b do not open, the opening of the first recess 501 is liquid-tightly sealed by the valve unit 505.

A second recess 508 that is recessed from the upper surface toward the lower surface is formed on the housing 403. A suction port 509 through which the liquid is sucked and a first discharge port 510a and a second discharge port 510b through which the liquid is discharged are formed in the housing 403. Each of the suction port 509, the first discharge port 510a, and the second discharge port 510b penetrates through the housing 403 from a bottom surface of the second recess 508 toward the lower surface of the housing 403 to a bottom section of the housing 403 along the vertical direction (Z direction).

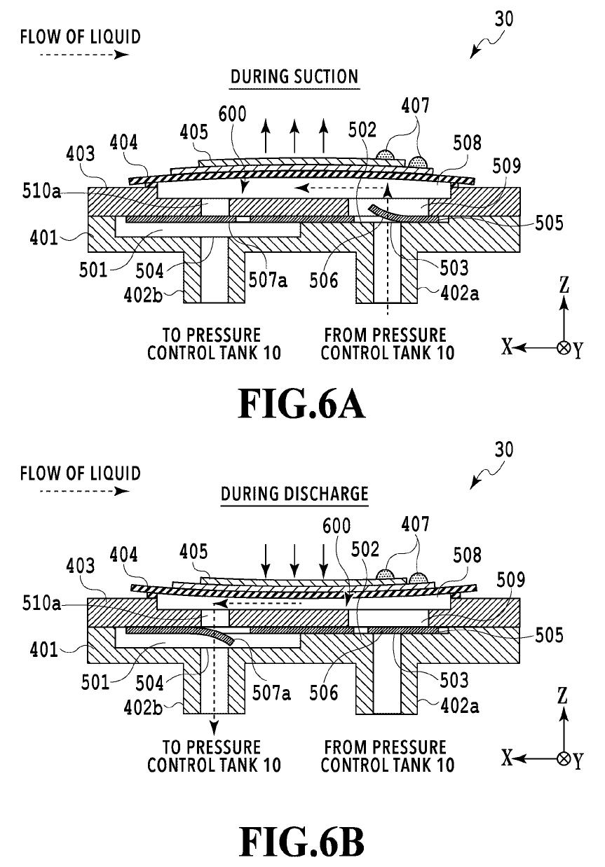

The number of the second discharge ports 510b is greater than the number of the first discharge ports 510a. According to this configuration, the bubble in the liquid that is mixed in a pump chamber 600 (see FIG. 6) is discharged more easily than a configuration including the same number of the second discharge ports 510b and the first discharge ports 510a.

Additionally, in a state in which the valve unit 505 is arranged between the connection member 401 and the housing 403, the first opening portion 503 and the suction port 509 are connected to each other with the suction valve 506 being arranged therebetween. The suction valve 506 is formed greater than the first opening portion 503 and is formed smaller than the suction port 509. According to this configuration, the suction valve 506 is allowed to be bent in a direction in which the liquid enters from the suction tube 402a into the pump chamber 600 and is not allowed to be bent in a direction in which the liquid is discharged from the pump chamber 600.

On the other hand, the first discharge port 510a is connected to the first recess 501 with the first discharge valve 507a being arranged therebetween, and the second discharge port 510b is connected to the first recess 501 with the second discharge valve 507b being arranged therebetween.

The first discharge valve 507a is formed greater than the first discharge port 510a and is formed smaller than the opening of the first recess 501. In addition, the second discharge valve 507b is formed greater than the second discharge port 510b and is formed smaller than the opening of the first recess 501. According to this configuration, each of the first discharge valve 507a and the second discharge valve 507b is allowed to be bent in a direction in which the liquid is discharged from the pump chamber 600 through the discharge tube 402b and is not allowed to be bent in a direction in which the liquid enters into the pump chamber 600.

The pump chamber 600 (see FIG. 6) is formed by fixing an outer periphery portion of the lower surface of the diaphragm 404 to an outer periphery portion of the upper surface of the housing 403 so as to cover the second recess 508. The actuator 405 that is driven by being supplied with power is provided to a central portion of the upper surface of the diaphragm 404.

In the circulation pump 30 of the present embodiment, a piezoelectric element that is driven by being applied with a voltage is used as the actuator 405. That is, the circulation pump 30 of the present embodiment is a piezoelectric pump of a diaphragm type. However, an example of the pump that can be used as the circulation pump 30 is not limited thereto. For example, an inner volume type pump such as a piston pump may be used as the circulation pump 30. Note that, a thickness of the diaphragm 404 in the present embodiment is about 0.4 mm. According to this configuration, it is possible to change a pressure inside the pump chamber 600 by efficiently transferring vibrations of the actuator 405.

Incidentally, the vicinity of an outer periphery of the diaphragm 404 has a smaller deformation amount than that in the vicinity of the center. For this reason, the vicinity of the outer periphery of the valve unit 505 tends to have a smaller force to push out the bubble than that in the vicinity of the center.

Therefore, the first discharge valve 507a and the second discharge valve 507b may be formed to have different thicknesses. Specifically, the first discharge valve 507a and the second discharge valve 507b may be formed such that the thickness of the second discharge valve 507b is smaller than that of the first discharge valve 507a. According to this configuration, it is possible to bend the second discharge valve 507b with a smaller force than that for the first discharge valve 507a. That is, according to this configuration, it is possible to improve the discharging property of the bubble more than a case where the first discharge valve 507a and the second discharge valve 507b have the same thickness.

Additionally, material of the first discharge valve 507a and material of the second discharge valve 507b may be different from each other. Specifically, the second discharge valve 507b may be formed of a material having lower rigidity than that of the first discharge valve 507a. For example, the second discharge valve 507b may be formed of rubber, and the first discharge valve 507a may be formed of metal.

According to this configuration, it is also possible to bend the second discharge valve 507b with a smaller force than that for the first discharge valve 507a. That is, according to this configuration, it is possible to improve the discharging property of the bubble more than a case where the first discharge valve 507a and the second discharge valve 507b are formed of the same material.

Moreover, as the valve unit 505, a sheet on which only the first discharge valve 507a is formed and a sheet on which only the second discharge valve 507b is formed may be used. However, with the first discharge valve 507a and the second discharge valve 507b being formed on one sheet, it is possible to reduce the number of members forming the circulation pump 30 more than a case of using the two sheets.

FIG. 6A is a diagram describing a flow of the liquid in a case where the liquid is sucked into the pump chamber 600 of the present embodiment.

As illustrated in FIG. 6A, the pump chamber 600 is formed by fixing the diaphragm 404 onto the housing 403 so as to cover the second recess 508. With the diaphragm 404 being deformed to increase an inner volume of the pump chamber 600, a state in which a pressure value of the pump chamber 600 is decreased (that is, a negative pressure is obtained), and a state in which the suction valve 506 is opened is obtained.

In a state in which the suction valve 506 is opened, the liquid is sucked from the pressure control tank 10 (see FIG. 1) to the pump chamber 600 while passing through the suction tube 402a, the first opening portion 503, the suction valve 506, and the suction port 509 in this order.

On the other hand, in a state in which there is a negative pressure in the pump chamber 600, the first discharge valve 507a is in a closed state, and no liquid flows from the first discharge port 510a to the first recess 501.

Note that, although it is not illustrated in FIG. 6A, in this state, the second discharge valve 507b (see FIG. 5) is also in a closed state, and no liquid flows from the second discharge port 510b (see FIG. 5) to the first recess 501.

FIG. 6B is a diagram describing a flow of the liquid in a case where the liquid is discharged from the pump chamber 600 of the present embodiment.

As illustrated in FIG. 6B, with the diaphragm 404 being deformed to decrease the inner volume of the pump chamber 600, the pressure value of the pump chamber 600 is increased (that is, a positive pressure is obtained), and a state in which the first discharge valve 507a is opened is obtained.

In a state in which the first discharge valve 507a is opened, the liquid is discharged from the pump chamber 600 to the pressure control tank 10 while passing through the first discharge port 510a, the first discharge valve 507a, the first recess 501, the second opening portion 504, and the discharge tube 402b in this order. Note that, in this state, the second discharge valve 507b is also in an open state, and the liquid is discharged from the second discharge port 510b to the first recess 501.

On the other hand, in this state, the suction valve 506 is in a closed state, and no liquid is discharged from the suction port 509 to the first opening portion 503.

Thus, in the circulation pump 30, the suction port 509 through which the liquid is sucked into the pump chamber 600 in which the internal pressure is changed and the first discharge port 510a and the second discharge port 510b through which the liquid and the bubble are discharged from the pump chamber 600 are formed. According to this configuration, even in a case where the bubble is mixed into the circulation pump 30, it is possible to discharge the bubble by repeating suction and discharge of the liquid to allow the liquid to flow.

Additionally, in an orientation of using the circulation pump 30 of the present embodiment, the first connection port 303a (see FIG. 3A) of the pressure control tank 10 (see FIG. 1 and the like) and the suction port 509 of the circulation pump 30 are formed along the vertical direction. In addition, the first discharge port 510a and the second connection port 303b (see FIG. 3A) are formed along the vertical direction.

According to this configuration, since the bubble has the property of rising upward in the vertical direction, even in a case where the bubble is mixed in the pressure control tank 10, it is possible to rectilinearly put the bubble with the liquid into the pump chamber 600 without stagnating the bubble inside the pressure control tank 10. In addition, it is possible to rectilinearly discharge the bubble with the liquid from the pump chamber 600.

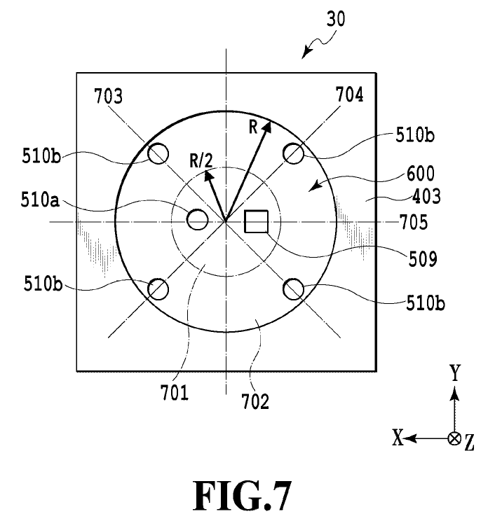

FIG. 7 is a schematic plan view of the circulation pump 30 in the present embodiment.

As illustrated in FIG. 7, in the vicinity of the center of the circulation pump 30 in the present embodiment, the suction port 509 through which the liquid enters into the pump chamber 600 in which the internal pressure is changed and the first discharge port 510a through which the liquid and the bubble are discharged from the pump chamber 600 are formed. On the other hand, in the vicinity of an outer periphery of the pump chamber 600, multiple second discharge ports 510b through which the liquid and the bubble are discharged from the pump chamber 600 are formed.

Note that, the number of the first discharge ports 510a may be one or more. However, the number of the second discharge ports 510b formed is greater than the number of the first discharge ports 510a formed. According to this configuration, even in a case where the bubble cannot be discharged from the first discharge port 510a, it is expected that the bubble is discharged from the second discharge port 510b.

Additionally, in an orientation of using the circulation pump 30, in a state of viewing the pump chamber 600 (more specifically, the housing 403) in a planar way, the shape of the pump chamber 600 is a circular shape.

Hereinafter, a radius of the pump chamber 600 in the present embodiment is written as "R." In addition, a half length of the radius of the pump chamber 600 is written as "R/2." Moreover, a region within a range of "R/2" from the center of the pump chamber 600 is called "central portion 701," and a region on an outer side of the central portion 701 in the inside of the pump chamber 600 is called "outer periphery portion 702."

The suction port 509 and the first discharge port 510a are formed in the central portion 701 of the pump chamber 600. The above-described diaphragm 404 (see FIG. 4 and the like) has the property of deforming greatly in the vicinity of the center more than in the vicinity of the outer periphery of the pump chamber 600. Therefore, with the suction port 509 and the first discharge port 510a being formed in the central portion 701, it is possible to put the liquid into and out of the pump chamber 600 efficiently in a case of activating the diaphragm 404.

On the other hand, the multiple second discharge ports 510b are formed in the outer periphery portion 702 of the pump chamber 600. Specifically, on a first imaginary line 703 passing through the center of the pump chamber 600, two or more of the multiple second discharge ports 510b face each other with the center of the pump chamber 600 being positioned therebetween. In addition, on a second imaginary line 704 passing through the center of the pump chamber 600 and crossing (specifically, orthogonal to) the first imaginary line 703, two or more of the multiple second discharge ports 510b face each other with the center of the pump chamber 600 being positioned therebetween.

That is, in the pump chamber 600 of the present embodiment, the four second discharge ports 510b are formed at intervals of 90 degrees about a rotation axis at the center of the pump chamber 600 from the vicinity of the outer periphery of the pump chamber 600 on the first imaginary line 703.

In addition, on a third imaginary line 705 passing through the center of the pump chamber 600 and crossing the first imaginary line 703 and the second imaginary line 704, the suction port 509 and the first discharge port 510a face each other with the center of the pump chamber 600 being positioned therebetween. Note that, specifically, the third imaginary line 705 is tilted at 45 degrees to the first imaginary line 703 and is tilted at 45 degrees to the second imaginary line 704.

Thus, with the multiple second discharge ports 510b being formed with a good balance, it is expected that even the bubble that cannot be discharged from the first discharge port 510a is discharged from a part of or all the multiple second discharge ports 510b.

The suction port 509 and the first discharge port 510a may have different sizes. The suction port 509 and the second discharge port 510b may have different sizes. Specifically, it is preferable that at least one of the first discharge port 510a and the second discharge port 510b is formed greater than the suction port 509. According to this configuration, it is possible to improve the discharging property of the bubble more than a case where each of the first discharge port 510a and the second discharge port 510b has a size equal to or smaller than the suction port 509.

The first discharge port 510a and the second discharge port 510b may have different sizes. Specifically, it is preferable that the second discharge port 510b is formed greater than the first discharge port 510a. According to this configuration, it is expected that the bubble is discharged from a part of or all the multiple second discharge ports 510b even in a case where the bubble cannot be discharged from the first discharge port 510a.

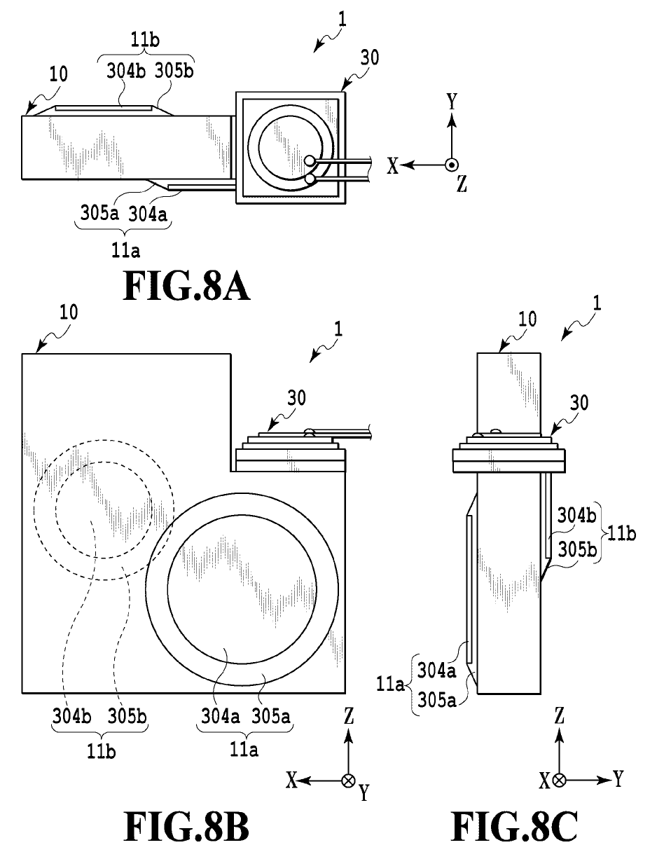

FIG. 8A is a schematic plan view of the liquid ejection head 1 in the present embodiment. FIG. 8B is a schematic front view of the liquid ejection head 1 in the present embodiment. FIG. 8C is a schematic side view of the liquid ejection head 1 in the present embodiment.

As illustrated in FIGS. 8A to 8C, the circulation pump 30 of the present embodiment is connected to the pressure control tank 10 such that the actuator 405 faces upward in the vertical direction. That is, the multiple second discharge ports 510b (see FIG. 7) are scattered on a plane surface extending in the horizontal direction. Therefore, regardless of the place where the bubble is stagnating in the pump chamber 600 (see FIG. 7 and the like), it is possible to position the second discharge port 510b near the bubble.

As described above, in the liquid ejection head 1 of the present embodiment, the second discharge port 510b that is not formed in the liquid ejection head of a conventional technique is formed. According to this configuration, it is expected that even the bubble that cannot be discharged from the first discharge port 510a (see FIG. 7) is discharged from the pump chamber 600 through the second discharge port 510b.

Therefore, according to the liquid ejection head 1 of the present embodiment, it is possible to discharge the bubble more easily.

### Modification 1 of Pump Chamber 600 of First Embodiment

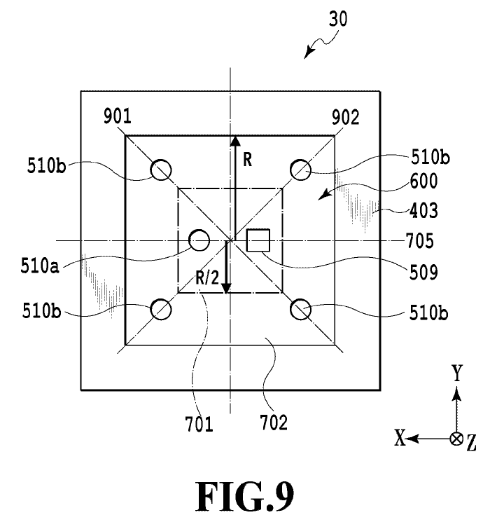

FIG. 9 is a diagram illustrating a modification of the pump chamber 600 in the present embodiment.

As illustrated in FIG. 9, in an orientation of using the circulation pump 30 in the present modification, the shape of the pump chamber 600 is a rectangular shape in a state of viewing in a planar way.

Hereinafter, a half length of one side of the pump chamber 600 in the present modification is written as "R." In addition, a half length of "R" is written as "R/2." Moreover, a region within a range of "R/2" from the center of the pump chamber 600 in the present modification is called "central portion 701," and a region on an outer side of the central portion 701 in the inside of the pump chamber 600 is called "outer periphery portion 702."

In the outer periphery portion 702 of the present modification, two second discharge ports 510b are formed on an imaginary first diagonal line 901 passing through the center of the pump chamber 600 so as to face each other with the center of the pump chamber 600 being positioned therebetween. In addition, two second discharge ports 510b are formed on an imaginary second diagonal line 902 passing through the center of the pump chamber 600 and orthogonal to the first diagonal line 901 so as to face each other with the center of the pump chamber 600 being positioned therebetween.

On the other hand, in the central portion 701, the first discharge port 510a and the suction port 509 are formed on the third imaginary line 705 passing through the center of the pump chamber 600 and crossing the first diagonal line 901 at a sharp angle so as to face each other with the center of the pump chamber 600 being positioned therebetween. Note that, the third imaginary line 705 in the present modification crosses the first diagonal line 901 at 45 degrees.

Thus, also in the liquid ejection head 1 in which the shape of the pump chamber 600 in a state of viewing in a planar way is a rectangular shape, it is possible to discharge the bubble from the pump chamber 600 more easily.

### Second Embodiment

Hereinafter, a liquid ejection head in a second embodiment is described with reference to the drawings. An object of the liquid ejection head in the present embodiment is to discharge the bubble more easily. In the following descriptions, a different point from the first embodiment is mainly described, and the constituent that is same as or corresponding to that in the first embodiment is denoted by the same reference numeral while the description thereof is omitted.

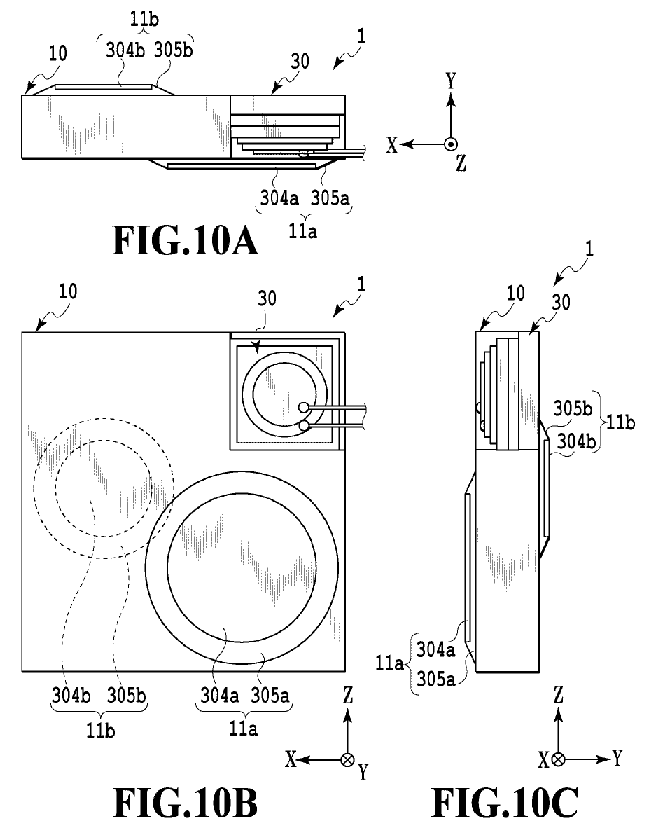

FIG. 10A is a schematic plan view of the liquid ejection head 1 in the present embodiment. FIG. 10B is a schematic front view of the liquid ejection head 1 in the present embodiment. FIG. 10C is a schematic side view of the liquid ejection head 1 in the present embodiment.

In the liquid ejection head 1 of the first embodiment, the circulation pump 30 is attached to the pressure control tank 10 such that the upper surface of the circulation pump 30 (surface of the actuator 405) faces upward in the vertical direction. However, as illustrated in FIGS. 10A to 10C, the circulation pump 30 may be attached to the pressure control tank 10 such that the upper surface of the circulation pump 30 faces in the horizontal direction (for example, on a front surface of the liquid ejection head 1).

Note that, in the example in FIG. 5, the suction tube 402a and the discharge tube 402b extend in a direction orthogonal to the bottom surface of the first recess 501. However, the suction tube 402a and the discharge tube 402b of the present embodiment extend parallel (horizontal) to the bottom surface of the first recess 501. That is, the suction tube 402a and the discharge tube 402b of the present embodiment extend in the X direction in FIG. 5. With the suction tube 402a and the discharge tube 402b being formed as described above, it is possible to attach the circulation pump 30 of the present embodiment to the pressure control tank 10.

According to this configuration, it is possible to reduce a space in the Y direction to arrange the circulation pump 30 more than the example in FIG. 1. That is, it is possible to slim down the liquid ejection head 1.

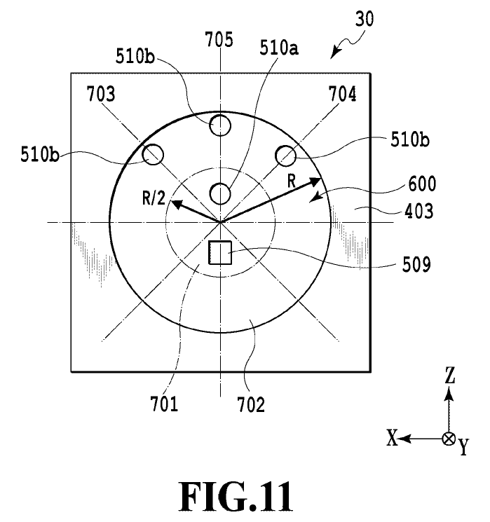

FIG. 11 is a schematic front view of the circulation pump 30 in the present embodiment. In FIG. 11, a radius of the pump chamber 600 that has a circular shape in a state of viewing from the front is written as "R." In addition, a half length of the radius of the pump chamber 600 that has a circular shape in a state of viewing from the front is written as "R/2."

As illustrated in FIG. 11, in an orientation of using the circulation pump 30 in the present embodiment, the pump chamber 600 has a circular shape in a state of viewing from the front.

In the pump chamber 600 of the present embodiment, the suction port 509, the first discharge port 510a, and one or more of the multiple second discharge ports 510b are formed on the third imaginary line 705 passing through the center. In addition, one or more of the multiple second discharge ports 510b are formed on the first imaginary line 703 passing through the center of the pump chamber 600 and crossing the third imaginary line 705 at a sharp angle. Moreover, one or more of the multiple second discharge ports 510b are formed on the second imaginary line 704 passing through the center of the pump chamber 600 and crossing the third imaginary line 705 and the first imaginary line 703.

Specifically, the third imaginary line 705 is tilted at 45 degrees to the first imaginary line 703 and is tilted at 45 degrees to the second imaginary line 704.

The first discharge port 510a of the present embodiment is formed on an upper side of the suction port 509 in the vertical direction. Each of the multiple second discharge ports 510b is formed on an upper side of the first discharge port 510a in the vertical direction.

As described above, the bubble has the property of rising upward in the vertical direction. For this reason, with the multiple second discharge ports 510b being formed on the upper side in the vertical direction with a good balance, it is expected that even the bubble that cannot be discharged from the first discharge port 510a is discharged from the second discharge port 510b.

In the pump chamber 600 of the present embodiment, the bubble is most likely to be discharged from the second discharge port 510b that is formed in the center of the three second discharge ports 510b. However, even in a case where the bubble is not discharged from the second discharge port 510b formed in the center, it is expected that the bubble is discharged from the two second discharge ports 510b formed on the two sides in a case where the bubble is moved in the horizontal direction.

Therefore, according to the liquid ejection head 1 in the present embodiment, it is possible to discharge the bubble more easily. In addition, it is also possible to slim down the liquid ejection head 1.

### Modification of Pump Chamber 600 of Second Embodiment

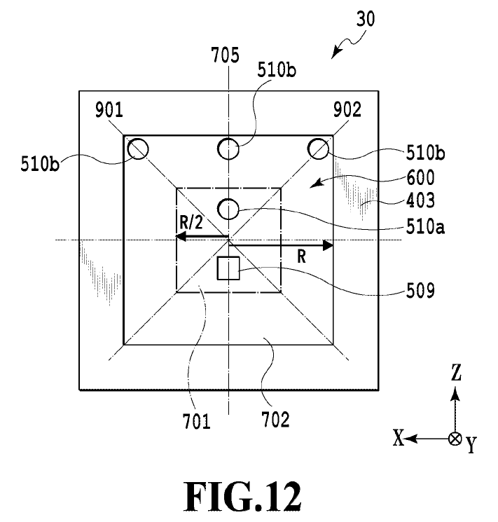

FIG. 12 is a diagram illustrating a modification of the pump chamber 600 in the present embodiment.

As illustrated in FIG. 12, in an orientation of using the circulation pump 30 in the present modification, the shape of the pump chamber 600 is a rectangular shape (specifically, square) in a state of viewing from the front. In FIG. 12, a half length of one side of the pump chamber 600 is written as "R." In addition, a half length of "R" is written as "R/2."

In the pump chamber 600 in the present modification, one or more of the multiple second discharge ports 510b are formed on the imaginary first diagonal line 901 passing through the center. In addition, one or more of the multiple second discharge ports 510b are formed on the imaginary second diagonal line 902 passing through the center of the pump chamber 600 and orthogonal to the first diagonal line 901. Moreover, the suction port 509, the first discharge port 510a, and one or more of the multiple second discharge ports 510b are formed on the third imaginary line 705 passing through the center of the pump chamber 600 and crossing the first diagonal line 901 and the second diagonal line 902.

The first discharge port 510a is formed on an upper side of the suction port 509. Each of the multiple second discharge ports 510b is formed on an upper side of the first discharge port 510a.

Note that, in the pump chamber 600 of the present modification, the third imaginary line 705 is tilted at 45 degrees to each of the first diagonal line 901 and the second diagonal line 902. In addition, three second discharge ports 510b are formed.

Thus, even in a case where the shape of the pump chamber 600 is a rectangular shape in a state of viewing from the front, with the suction port 509 and the first discharge port 510a being formed in the central portion 701, it is possible to efficiently put the liquid into and out of the pump chamber 600. In addition, with the multiple second discharge ports 510b being formed with a good balance in the outer periphery portion 702, it is expected that even the bubble that cannot be discharged from the first discharge port 510a is discharged from a part of or all the multiple second discharge ports 510b.

That is, according to this configuration, it is also possible to discharge the bubble more easily while slimming down the liquid ejection head 1.

### Other Embodiments

In the example in FIG. 6A, with the suction port 509 being formed greater than the first opening portion 503, the suction valve 506 is allowed to be bent toward the suction port 509, and the suction of the liquid is allowed.

On the other hand, in the example in FIG. 6B, with the opening of the first recess 501 being formed greater than the first discharge port 510a, the first discharge valve 507a is allowed to be bent toward the first recess 501, and the discharge of the liquid is allowed.

However, a configuration in which the shape of the valve unit 505 is creative so as to be bent in only one direction, either the direction of sucking the liquid or the direction of discharging the liquid, may be applied. For example, a notch may be formed at a portion that is a starting point of bending of a surface of the valve unit 505 where the liquid is received, and thus the bending in only one direction, either the direction of sucking the liquid or the direction of discharging the liquid, may be allowed. According to this configuration, it is also possible to discharge the bubble more easily.

According to the liquid ejection head of the present disclosure, it is possible to discharge the bubble more easily.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-038340, filed Mar. 11, 2025, which is hereby incorporated by reference herein in its entirety.

What is claimed is:

1. A liquid ejection head, comprising:
a liquid ejection unit configured to eject a liquid;
a tank configured to store the liquid to be supplied to the liquid ejection unit; and
a circulation pump configured to circulate the liquid between the tank and the liquid ejection unit, wherein
the circulation pump includes
a pump chamber in which an inner volume is changed,
a suction port configured to allow for entry of the liquid but not to allow for discharge of the liquid, and
a plurality of discharge ports configured to allow for discharge of the liquid but not to allow for entry of the liquid.

2. The liquid ejection head according to claim 1, wherein
the plurality of discharge ports include
a first discharge port formed in a position closer to the center of the pump chamber than an outer periphery of the pump chamber and
a second discharge port formed in a position closer to the outer periphery of the pump chamber than the center.

3. The liquid ejection head according to claim 2, wherein
the number of the second discharge ports is greater than the number of the first discharge ports.

4. The liquid ejection head according to claim 2, wherein
in an orientation of using the liquid ejection head, in a case of viewing the pump chamber from above, at least two of the second discharge ports are formed on a first imaginary line passing through the center, with the center being positioned therebetween, and at least other two of the second discharge ports are formed on a second imaginary line crossing the first imaginary line at the center, with the center being positioned therebetween.

5. The liquid ejection head according to claim 2, wherein
the tank includes
a first connection port connected to the suction port and
a second connection port connected to the first discharge port, and
in an orientation of using the liquid ejection head, the first connection port and the suction port are arranged along a vertical direction, and
the first discharge port and the second connection port are arranged along the vertical direction.

6. The liquid ejection head according to claim 2, wherein
the circulation pump further includes
a suction valve configured to allow for entry of the liquid from the suction port but not to allow for discharge of the liquid from the suction port,
a first discharge valve configured to allow for discharge of the liquid from the first discharge port but not to allow for entry of the liquid from the first discharge port, and
a second discharge valve configured to allow for discharge of the liquid from the second discharge port but not to allow for entry of the liquid from the second discharge port.

7. The liquid ejection head according to claim 6, wherein
the suction valve is smaller than the suction port,
the first discharge valve is greater than the first discharge port, and
the second discharge valve is greater than the second discharge port.

8. The liquid ejection head according to claim 7, wherein
the circulation pump further includes
a first opening portion connected to the suction valve and
a connection member on which a recess including an opening connected to the first discharge valve and the second discharge valve is formed, and
the suction valve is greater than the first opening portion and configured not to allow for discharge of the liquid from the pump chamber, and
the first discharge valve and the second discharge valve are smaller than the opening of the recess and configured to allow for discharge of the liquid from the pump chamber.

9. The liquid ejection head according to claim 7, wherein
the suction valve, the first discharge valve, and the second discharge valve are formed in one sheet having flexibility.

10. The liquid ejection head according to claim 6, wherein
a thickness of the second discharge valve is smaller than a thickness of the first discharge valve.

11. The liquid ejection head according to claim 6, wherein
the second discharge valve is formed of a material having lower rigidity than that of the first discharge valve.

12. The liquid ejection head according to claim 2, wherein
at least one of the first discharge port and the second discharge port is greater than the suction port.

13. The liquid ejection head according to claim 2, wherein
the second discharge port is greater than the first discharge port.

14. The liquid ejection head according to claim 1, wherein
in an orientation of using the liquid ejection head, in a case of viewing the pump chamber from above, the pump chamber has a circular shape or a rectangular shape.

15. The liquid ejection head according to claim 2, wherein
in an orientation of using the liquid ejection head, in a case of viewing the pump chamber from front,
the suction port is formed on a lower side of the center in a vertical direction,
the first discharge port is formed on an upper side of the center in the vertical direction, and
the second discharge port is formed on an upper side of the first discharge port in the vertical direction.

16. The liquid ejection head according to claim 15, wherein
in an orientation of using the liquid ejection head, in a case of viewing the pump chamber from front, the pump chamber has a circular shape or a rectangular shape.

17. The liquid ejection head according to claim 1, wherein
the pump chamber includes
a piezoelectric element configured to be driven by being supplied with power and
a diaphragm connected to the piezoelectric element, and
the inner volume is changed by deformation of the diaphragm.

18. The liquid ejection head according to claim 1, wherein
the tank includes
a first pressure control unit configured to control a pressure of the liquid supplied from an external liquid storage unit and
a second pressure control unit configured to control a pressure of the liquid to be supplied to the liquid ejection unit.

19. The liquid ejection head according to claim 1, wherein
a plurality of the tanks are connected to the liquid ejection unit,
the circulation pump is connected to each of the plurality of the tanks, and
different types of liquids are stored in the plurality of the tanks, respectively.

20. A liquid ejection apparatus, comprising:
a liquid ejection head including a liquid ejection unit configured to eject a liquid, a tank configured to store the liquid to be supplied to the liquid ejection unit, and a circulation pump configured to circulate the liquid between the tank and the liquid ejection unit; and
a liquid tank configured to store the liquid to be supplied to the tank, wherein
the circulation pump includes
a pump chamber in which an inner volume is changed,
a suction port configured to allow for entry of the liquid but not to allow for discharge of the liquid, and
a plurality of discharge ports configured to allow for discharge of the liquid but not to allow for entry of the liquid.
